(19) United States
(12) Patent Application Publication
(10) Pub. No.: US 2016/0340255 A1
(43) Pub. Date: Nov. 24, 2016

(54) OXYGEN CONDUCTING BISMUTH PEROVSKITE MATERIAL

(71) Applicants: HEWLETT-PACKARD DEVELOPMENT COMPANY, L.P., Houston, TX (US); THE STATE OF OREGON acting by and through THE STATE BOARD OF HIGHER EDUCATION on behaf of OREGON, Corvallis, OR (US)

(72) Inventors: David Cann, Corvalis, OR (US); Brady Gibbons, Corvalis, OR (US); Narit Triamnak, Corvalis, OR (US); James Elmer Abbott Jr., Corvalis, OR (US)

(73) Assignee: HEWLETT-PACKARD DEVELOPMENT COMPANY, L.P., Houston, TX (US)

(21) Appl. No.: 15/113,873

(22) PCT Filed: Jan. 29, 2014
(86) PCT No.: PCT/US2014/013611

§ 371 Date: Jul. 25, 2016

(51) Int. Cl. C04B 35/475; G01N 27/407; C04B 35/64

(52) U.S. Cl. CPC C04B 35/475; C04B 35/64; G01N 27/4073; C04B 2235/3298; C04B 2235/3234; C04B 2235/3236; C04B 2235/3201; C04B 2235/3206; C04B 2235/768; C04B 2235/79

(57) ABSTRACT

The present disclosure is drawn to an oxygen conducting bismuth perovskite material, a method of conducting oxygen through the material, and a method of making the material. The oxygen conducting bismuth perovskite material can include two components selected from the group consisting of NBT, KBT, BZT, BMT, and BNiT. The material can also have a sufficient degree of non-stoichiometry to provide oxygen vacancies to conduct oxide ions.

### BACKGROUND

Oxygen conducting materials have been used in a variety of applications, including solid electrolytes, oxygen sensors, oxygen membranes, and other ionic devices. One widely-used oxygen conductor is modified zirconia, or ZrO₂. This material is known as a “fast ion conductor” because of its ability to transport oxide ions. The diffusivity of oxygen in ZrO₂ can be greatly increased by doping pure ZrO₂ with relatively small amounts of dopants. For example, yttrium stabilized zirconia (YSZ) is formed by doping ZrO₂ with small amounts of Y₂O₃. Other oxygen conducting materials have also been developed, such as CeO₂ and LaGaO₃. These materials are usually used in applications where oxygen diffusion is driven by chemical potential, such as oxygen sensors and solid electrolytes. Because of the potential usefulness of such materials, research continues in the area of oxygen conducting materials.

### BRIEF DESCRIPTION OF THE DRAWINGS

FIG. 1 is a schematic representation of an oxygen conducting bismuth perovskite material between metal electrodes in accordance with an example of the present disclosure;

FIG. 2 is graph of impedance and dielectric modulus data for a BNT-BMT material between silver (Ag) electrodes in accordance with an example of the present disclosure;

FIG. 3 is a schematic representation of an oxygen conducting bismuth perovskite material between oxide electrodes in accordance with an example of the present disclosure; and

FIG. 4 is graph of impedance and dielectric modulus data for a BNT-BMT material between indium tin oxide (ITO) electrodes in accordance with an example of the present disclosure.

### DETAILED DESCRIPTION

Certain bismuth-containing perovskite materials can be prepared with high levels of oxygen conducting capability. In many cases, this can be accomplished by processing the material in such a way that a degree of non-stoichiometry is intentionally introduced into the material. Most bismuth perovskite materials in their pure form, for example bismuth sodium titanate, Bi_{0.5}Na_{0.5}TiO₃, with typical stoichiometry and crystal structure, normally have relatively low oxygen conductivities. However, deviating from the stoichiometry of the pure material can create defects in the crystal structure that provide pathways for the diffusion of oxygen. Non-stoichiometry can be caused by, for example, a deficiency in one or more of the ions making up the material, or the addition of dopants in place of one or more of the ions making up the material.

Some bismuth perovskite materials also have unusually large piezoelectric coefficients and generally have electrostrictive characteristics. For example, piezoelectric and electrostrictive bismuth perovskite materials can be formed by mixing various combinations of Na_{0.5}Bi_{0.5}TiO₃ (NBT), K_{0.5}Bi_{0.5}TiO₃ (KBT), BiZn_{0.5}Ti_{0.5}O₃ (BZT), BiMg_{0.5}Ti_{0.5}O₃ (BMT), and BiNi_{0.5}Ti_{0.5}O₃ (BNiT). These materials have unique structural characteristics that can make them highly electromechanically active. First, the materials possess a number of possible structural distortions that are very close in energy. One consequence of this is that the structures are highly compliant and are thus highly responsive to external stimuli (and hence produce large field-induced strains). Second, some of these compositions can undergo an electric field-induced phase transformation (e.g. from a cubic phase to a tetragonal phase). A large change in volume (and polarization) accompanies this phase transition.

Without being limited to a specific mechanism, the structural characteristics that make these materials piezoelectric and electrostrictive may also contribute to their high oxygen conductivity. The compliant crystal structure of the bismuth perovskite materials may enable low energy pathways for oxygen ion conduction. Materials that exhibit oxygen conductivity, ferroelectric properties, and piezoelectric and electrostrictive properties can potentially have many more functionalities than conventional oxygen conducting materials such as ZrO₂. For example, ZrO₂ is limited to applications in which chemical potential is the driving force for oxygen transport. The unique functionality of piezoelectric and electrostrictive oxygen conducting bismuth perovskite materials can enable many other capabilities. For example, in ferroelectric materials, the polarization state can generate an internal electric field which can strongly influence ionic transport. Therefore, the oxygen conductivity of the bismuth perovskite material can be switched on or off by application of a voltage. Also, because piezoelectric and electrostrictive materials respond to external stress, the oxygen conductivity of the bismuth perovskite material can be modulated by applying physical stress or an acoustic signal. Many other unique functionalities are possible with the realization of an oxygen conducting material with electrically responsive characteristics.

In accordance with this, the present disclosure is drawn to an oxygen conducting bismuth perovskite material, comprising two components (which includes two or more) selected from the group consisting of NBT, KBT, BZT, BMT, and BNiT, wherein the material has a sufficient degree of non-stoichiometry to provide oxygen vacancies to conduct oxide ions.

Alternatively, a method of conducting oxygen through a ceramic material can comprise passing oxide ions through oxygen vacancies in the material, wherein the material comprises two components selected from the group consisting of NBT, KBT, BZT, BMT, and BNiT.

The present disclosure is also drawn to a method of making an oxygen conducting ceramic material comprising mixing starting powders selected from ZnO, NiO, MgO, MgCO₃, Bi₂O₃, TiO₂, NaCO₃, and KCO₃ and sintering the starting powders to form an oxygen conducting ceramic material, wherein the starting powders are selected according to a ratio such that the oxygen conducting ceramic material comprises two components selected from the group consisting of NBT, KBT, BZT, BMT, and BNiT, and the oxygen conducting ceramic material has a sufficient degree of non-stoichiometry to provide oxygen vacancies to conduct oxide ions

In each of the various embodiments described herein, whether discussing the oxygen conducting bismuth perovskite material or related methods, there may be some common features that further characterize options in accordance with principles discussed herein. Thus, any discussion of the materials or methods, either alone or in combination, is also applicable to the other embodiment not specifically mentioned. For example, a discussion of the oxygen conductivity in the context of the materials is also applicable to the related methods, and vice versa.

Generally, oxygen conducting bismuth perovskite materials in accordance with the disclosed technology can include a variety of combinations of NBT, KBT, BZT, BMT, and BNiT. As used herein, the names of these components (NBT, KBT, BZT, BMT, and BNiT) are used to refer to both the pure, stoichiometrically perfect materials, as well as these materials with a degree of non-stoichiometry or doping included. For example, NBT normally refers to a sodium bismuth titanate perovskite compound, with the nominal composition of Na_{0.5}Bi_{0.5}TiO₃. In this disclosure, “NBT” can refer to this compound with an exact stoichiometric mixture of sodium, bismuth, titanium, and oxygen atoms. However, “NBT” can also be used to refer to this material with a degree of non-stoichiometry, such as Na_{0.5}Bi_{0.49}TiO_{2.985} or the material with dopant such as Na_{0.5}Bi_{0.49}Ti_{0.98}Mg_{0.02}O_{2.965}. Each of these variations can be referred to herein as “NBT.” It is also common to add a subscript to the initial of the element with non-stoichiometry, such as referring to Na_{0.5}Bi_{0.49}TiO_{2.985} as “NB_{0.49}T.” This naming convention may also be used herein. Similarly, the names of the other perovskite compounds KBT, BZT, BMT, and BNiT can be used herein to refer to the stoichiometrically perfect compounds or the compounds with a degree of non-stoichiometry and/or dopant. Furthermore, reordering initials of the elements in the compound name does not change the compound. Therefore, “NBT” is the same as “BNT” and “KBT” is the same as “BKT.” That being described, as the present disclosure utilizes non-stoichiometry to generate oxygen conductivity, it is understood that at least some component in any material is non-stoichiometric. For example, when describing an oxygen conducting bismuth perovskite material with two components selected from the group consisting of NBT, KBT, BZT, BMT, and BNiT, the material will have a sufficient degree of non-stoichiometry to provide oxygen vacancies to conduct oxide ions so that two or more of these materials are present, and at least one (or two or three, etc.) of these materials is non-stoichiometric in its configuration.

Perovskites are generally any material with the same type of crystal structure as calcium titanium oxide (CaTiO₃). The perovskite structure is adopted by many oxides with the formula ABO₃. Normally, A is a large cation with an oxidation state of +2, and B is a smaller cation with an oxidation state of +4. The perovskite compounds involved in the presently disclosed technology are more complicated examples of perovskites because they contain either two different A-site cations or two different B-site cations. For example, NBT has two A-site cations: Na²⁺ and Bi²⁺. BZT, on the other hand, has two B-site cations: Zn⁴⁺ and Ti⁴⁺. The perovskite crystal structure can be made up of cubic (or non-cubic) cells with A cations at the corners, a B cation in the center, and anions at the center of each face. Depending on conditions, these materials can shift into other crystal structures such as orthorhombic or tetragonal phases. However, in some examples of the present technology, the perovskite material can comprise a solid solution having a stable perovskite structure. The perovskite structure can be stable at temperatures ranging from absolute zero to 1000° C., in atmospheres comprising of an oxygen partial pressure ranging from pure oxygen down to oxygen partial pressures of 10⁻⁵⁰ . It is noted that individual compounds selected from NBT, KBT, BZT, BMT, and BNiT can have a stable perovskite structure, and combinations of two, three, or more of these compounds can also have a stable perovskite structure.

In some examples, an oxygen conducting bismuth perovskite material can include two of the perovskite compounds selected from NBT, KBT, BZT, BMT, and BNiT. In one such example, the oxygen conducting material can be NBT-BMT. Other examples include KBT-BMT, KBT-NBT, KBT- BZT, BNiT-NBT, or BNiT-KBT. In some examples, the oxygen conducting material can have one of the following general chemical formulas:

xBNiT-yKBT,

wherein x+y=1 and x≦0.25 based on the solubility limit of BNiT; or

xBNiT-zNBT,

wherein x+z=1 and x≦0.25.

Some, but not all, of the above binary compositions have stable perovskite structures. Many compositions with stable perovskite structures can be found according to the above chemical formulas when 0<x<0.25, where x corresponds to the mole fraction of either BZT, BMT, or BNiT.

In other examples, the oxygen conducting material can have one of the following general chemical formulas:

xBMT-yKBT,

wherein x+y=1 and x≦0.25; or

xBMT-zNBT,

wherein x+z=1 and x≦0.25.

Many compositions with stable perovskite structures can be found according to these chemical formulas when 0<x<0.25. In one specific example, the oxygen conducting material can be 80NBT-20BMT, which has the chemical formula (0.8)NBT-(0.2)BMT. In another specific example, the oxygen conducting material can be 10BZT-90KBT, which has the chemical formula (0.1 )BZT-(0.9)KBT.

In still further examples, an oxygen conducting bismuth perovskite material can include three of the perovskite compounds selected from NBT, KBT, BZT, BMT, and BNiT. Several possible ternary compositions include BZT-KBT-NBT, BNiT-KBT-NBT, and BMT-KBT-NBT.

In one such example, an oxygen conducting material can have the general chemical formula xBZT-yKBT-zNBT, wherein x+y+z=1 and x, y, z≠0. Many compositions according to the above general chemical formula can have stable perovskite structures when 0<x<0.25, 0.01<y<0.99, and 0.01<z<0.99. In other examples, the oxygen conducting material can have the above general chemical formula wherein 0<x<0.10, 0.01<y<0.99, and 0.01<z<0.99. In yet other examples, the oxygen conducting material can have the above general chemical formula wherein 0<x<0.19, y=0.28−0.50 and z=0.40−0.65. Compositions in this range can have especially high maximum electromechanical strain coefficients (d₃₃), as discussed further below. In still more examples, the oxygen conducting material can have any composition according to the above general chemical formula except for compositions where 0.01<x<0.25, 0.01<y<0.99 and 0.01<z<0.99.

Other ternary compositions can be obtained according to the general chemical formula xBNiT-yKBT-zNBT, wherein x+y+z=1, and x, y, z≠0. Many compositions according to this chemical formula can have stable perovskite structures when 0.01<x<0.25. Additional ternary compositions can be obtained by the general chemical formula xBMT-yKBT-zNBT, wherein x+y+z=1, and x, y, z≠0. Many compositions according to this chemical formula can have stable perovskite structures when 0.01<x<0.25.

Beyond ternary compositions, oxygen conducting materials can also include combinations of four of the perovskite compounds selected from NBT, KBT, BZT, BMT, and BNiT. All five of these compounds can also be combined. Furthermore, the oxygen conducting materials are not limited to containing only these perovskite compounds. Rather, the oxygen conducting materials can contain other components as well.

An oxygen conducting bismuth perovskite material, whether its composition is one of the specific compositions listed above or any other composition, can have a sufficient degree of non-stoichiometry to provide oxygen vacancies to conduct oxide ions. “Non-stoichiometry,” as used herein, refers to a deviation from the normal stoichiometric ratios of the various elements in a perovskite compound. For example, in NBT with perfect stoichiometric ratios, the number of Na, Bi, Ti, and O atoms are proportional to the stoichiometric coefficients in the nominal composition Na_{0.5}Bi_{0.5}TiO₃. However, Na_{0.5}Bi_{0.49}TiO_{2.985} is NBT with a small degree of non-stoichiometry due to a deficiency of bismuth. In many cases the non-stoichiometry can be a deficiency of one or more of the elements. In other examples, the non-stoichiometry can be an overabundance of an element, or an overabundance of one element together with a deficiency of another element. One will appreciate that a deficiency of one element is equivalent to an overabundance of all the other elements as far as ratios between the elements are concerned. Therefore, non-stoichiometry generally refers to any deviation from the stoichiometric ratios of the elements in a perfect perovskite material. As explained above, non-stoichiometry causes defects in the perovskite crystal structure that allow oxygen ions to pass through. In some examples, replacing a portion of one type of atom with a dopant can create the non-stoichiometry. For example, in Na_{0.5}Bi_{0.49}Ti_{0.98}Mg_{0.02}O_{2.965}, some of the titanium atoms are replaced by magnesium. This creates a non-stoichiometry because of the deficiency in titanium, and it also creates oxygen vacancies for conducting oxide ions.

In some cases, non-stoichiometry in the oxygen conducting material can degrade other properties of the material. For example, the piezoelectric and electrostrictive properties of the material can be impacted by deviating from the stoichiometry of the perfect perovskite material. Therefore, the non-stoichiometry can be optimized to provide both oxygen conducting properties and piezoelectric and electrostrictive properties. The optimal level of non-stoichiometry may be different depending on the application. In many examples, a relatively small level of non-stoichiometry can be sufficient to cause oxygen conducting. In some examples, the level of non-stoichiometry can be sufficient to give the material an oxygen conductivity of at least 0.001 S/cm at 600° C.

In some other examples, the non-stoichiometry can be a deficiency in one of the elements, wherein the deficiency is a reduction in the element's stoichiometric coefficient by 0.1 or less. In other examples, the reduction can be by 0.05 or less, or 0.01 or less. As used herein, the stoichiometric coefficient of an element in a perovskite compound is based on a stoichiometric coefficient of 3 for oxygen, 1 for the A cation, and 1 for the B cation. In compounds with two A cations or two B cations, the cations each have a stoichiometric coefficient of 0.5 instead of 1. For example, NBT normally has the nominal composition Na_{0.5}Bi_{0.5}TiO₃, but if it is prepared with the composition Na_{0.5}Bi_{0.49}TiO_{2.985}, then the stoichiometric coefficient of Bi has been reduced by 0.01.

In several examples, the non-stoichiometry can be a deficiency of bismuth. In one example, the stoichiometric coefficient of bismuth can be reduced by as much as 0.1. When the stoichiometric coefficient of bismuth is reduced, the amount of oxygen in the perovskite compound is also reduced. Accordingly, a bismuth-deficient perovskite compound can have a nominal composition given by one of the following chemical formulas:

(Na_{0.5}Bi_{0.5-x})TiO_{3±δ},

(K_{0.5}Bi_{0.5-x})TiO_{3±δ},

Bi₁₋ₓ(Zn_{0.5}Ti_{0.5})O_{3±5},

Bi₁₋ₓ(Mg_{0.5}Ti_{0.5})O_{3±δ},

or

Bi₁₋ₓ(Ni_{0.5}Ti_{0.5})O_{3±δ}

where x is from 0 to 0.1, and δ is from 0 to 0.15. The change in oxygen, δ, is a variable that is normally not directly controlled during the making of the perovskite material. Rather, this value depends on the amounts of other elements as well as the environmental partial pressure of oxygen where the material is synthesized. More generally, non-stoichiometry can be caused by a deficiency or overabundance of any of the elements in the material. For example, some examples of non-stoichiometric perovskite compounds can be obtained according to the following chemical formulas:

(Na_{0.5-y}Bi_{0.5-x})Ti₁₋ₓO_{3±δ},

(K_{0.5-y}Bi_{0.5-x})Ti₁₋ₓO_{3±δ},

Bi₁₋ₓ(Zn_{0.5-y}Ti_{0.5-z})O_{3±δ},

Bi₁₋ₓ(Mg_{0.5-y}Ti_{0.5-z})O_{3±δ},

or

Bi₁₋ₓ(Ni_{0.5-y}Ti_{0.5-z})O_{3±δ}

where x, y, and z range independently from 0 to 0.1.

In other examples, dopants can be added to increase oxygen conductivity. Acceptor dopants can greatly increase the diffusion coefficient of oxygen within the crystal structure. Suitable dopants can include Mg, Ni, Zn, Sc, Fe, Mn, and others. In one example, the oxygen conducting material can be doped with about 1 at % to about 5 at % of Mg. As used herein, at % (atom percent) refers to a percentage of all atoms in the oxygen conducting material. An oxygen conducting material can also have non-stoichiometry due to a deficiency in bismuth as well as due to doping. For example, in Na_{0.5}Bi_{0.49}Ti_{0.98}Mg_{0.02}O_{2.965}, there is a deficiency of bismuth as well as doping with magnesium. The magnesium atoms take the place of titanium atoms, thus causing a deficiency of titanium. In compounds such as this one, doping can further increase oxygen conductivity over what it would be with a deficiency of bismuth alone. Generally, doped perovskite compounds can include dopants as well as non-stoichiometry with respect to any of the other elements in the compound. For example, doped non-stoichiometric perovskite compounds can be obtained according to the following chemical formulas:

(Na_{0.05-y}Bi_{0.5-x})Ti_{1-z}D_{z}O_{3±δ},

(K_{0.05-y}Bi_{0.5-x})Ti_{1-z}D_{z}O_{3±δ},

Bi₁₋ₓ(Zn_{0.5-y}Ti_{0.5-z})D_{z}O_{3±δ},

Bi₁₋ₓ(Mg_{0.5-y}Ti_{0.5-z})D_{z}O_{3±δ},

or

Bi₁₋ₓ(Ni_{0.5-y}Ti_{0.5-z})D_{z}O_{3±δ}

where D is a dopant, x+y+z=1, and z≦0.1.

As explained above, the oxygen conducting bismuth perovskite materials of the present technology can also be piezoelectric and electrostrictive. In some examples, the material can have a maximum effective electromechanical strain coefficient (d₃₃*) in the range of about 200 pm/V to about 700 pm/V. For instance, some compositions of BZT-BKT-BNT can have a d₃₃* coefficient in the range of about 400 pm/V to about 650 pm/V. These materials can be optimized to have piezoelectric and electrostrictive properties meeting or exceeding the properties of other common piezoelectric and electrostrictive ceramics, such as lead zirconate titanate. A material that has good piezoelectric and electrostrictive properties as well as good oxygen conductivity can be especially useful. The oxygen conductivity of such a material can be modulated by applying a voltage, an external stress, an acoustic signal, or combinations thereof.

The present technology is also directed to a method of conducting oxygen through a ceramic material, comprising passing oxide ions through oxygen vacancies in the material, wherein the material comprises two components selected from the group consisting of NBT, KBT, BZT, BMT, and BNiT. When the ceramic material is designed as explained above, to allow the material to conduct oxygen, oxide ions can readily pass through. When the material has piezoelectric or electrostrictive properties, oxide ions can be passed through the material under a driving force comprising an external mechanical stress within the material. Also, the oxygen conductivity of the material can be modulated by applying a voltage, an external stress, an acoustic signal, or combinations thereof. These capabilities of the oxygen conducting materials of the present technology are not shared by other oxygen conducting materials, such as ZrO₂ which is not piezoelectric.

The present technology is also directed to a method of making an oxygen conducting ceramic material, comprising mixing starting powders selected from ZnO, NiO, MgO, MgCO₃, Bi₂O₃, TiO₂, NaCO₃ and KCO₃ and sintering the starting powders to form an oxygen conducting ceramic material, wherein the starting powders are selected according to a ratio such that the oxygen conducting ceramic material comprises two components selected from the group consisting of NBT, KBT, BZT, BMT, and BNiT, and the oxygen conducting ceramic material has a sufficient degree of non-stoichiometry to provide oxygen vacancies to conduct oxide ions.

The oxygen conducting ceramic materials can be made by any suitable solid-state synthesis method, using starting powders such as Bi₂O₃, NaCO₃, KCO₃, ZnO, and TIO₂. The Curie temperature (T_{c}) of the resulting product is generally between about 100° C. and about 500° C. The T_{c} of a piezoelectric ceramic may be increased or decreased by varying the relative amounts of the starting powders. The relative amounts of NBT, KBT, BZT, BMT, and BNiT may be adjusted so that the product will have a T_{c} in a specified range. In accordance with conventional solid state synthesis methods for making ceramic materials, the powders are milled, shaped and calcined to produce the desired ceramic product. Milling can be either wet or dry type milling, as is known in the art. High energy vibratory milling may be used, for instance, to mix starting powders and for post-calcination grinding. The powders can be mixed with a suitable liquid {e.g., ethanol or water, or a combination of liquids) and wet milled with a suitable high density milling media {e.g., yttria stabilized zirconia (YSZ) beads). The milled powders can be calcined, then mixed with a binder, formed into the desired shape {e.g., pellets) and sintered to produce a ceramic product with high sintered density.

Binary (i.e. having two end members) or ternary (i.e. having three end members) compositions can be produced via solid-state synthesis methods, using the appropriate amounts of ZnO, NiO, MgO, (or MgCO₃) Bi₂O₃, TiO₂, NaCO₃ and KCO₃ starting powders of at least 99% purity. Appropriate amounts of those powders can be combined to yield the final binary composition xBZT-yBNT, xBMT-yBNT, xBNiT-yBNT, xBZT-yBKT, xBMT-yBKT, or xBNiT-yBKT, wherein x+y=1. Alternatively, appropriate amounts of the starting powders can combined to yield the final ternary composition with the general chemical formula xBZT-yBKT-zBNT, xBMT-yBKT-zBNT, or xBNiT-yBKT-zBNT, wherein x+y+z=1.

When the intended use of the binary or ternary ceramic material utilizes a thin film product, the production method can be modified to include chemical solution deposition using chemical precursors such bismuth nitrate, titanium isopropoxide, etc., or sputtering using solid state sintered or hot-pressed ceramic targets. Any suitable sputtering or chemical deposition method can be used for this purpose. The resulting thin film ceramic can have a thickness in the range of about 50 nm to about 10 μm, in some cases.

For end uses such as sensors or transducers, which may use piezoelectric composites, the above-described sintered binary or ternary ceramic materials can be modified for this purpose. The ceramic powder can be ground or milled to the desired particle size and loaded into polymer matrix to create a 0-3 piezoelectric composite. The ceramic powder can be formed into sintered rods or fibers using injection molding or similar technique and loaded into a polymer matrix to create a 1-3 piezoelectric composite. The polymer may be piezoelectric, such as PVDF, or non-piezoelectric, such as epoxy, depending on the final application.

### Example 1

An NBT-BMT material was prepared with relative proportions (mole percent) 5BMT-95BNT. Six hours of high energy vibratory milling was used for mixing starting powders and for post-calcination grinding. Ethanol mixtures containing 15 vol % powder were milled with high density YSZ beads approximately ⅜ inch in diameter. After removal of YSZ, calcination was performed on the milled powder in covered crucibles at 900° C. for 6 hours. The calcined powders were mixed with a 3 wt % solution of Polyvinyl Butyral (PVB) binder, and the powders were uniaxially cold pressed into 12.7 mm pellets at a pressure of 150 MPa. Following a 400° C. binder burnout step, the pellets were sintered in covered crucibles at 1100° C. for 2 hours. Prior to electrical measurements, the ceramics discs were polished to thickness of 1 mm with smooth and parallel surfaces. Electrodes were applied using two different methods. Silver paste (Heraeus C1000) is fired on both sides in air at 650° C. for 30 minutes. The final dimensions of the specimen were 10 mm diameter and 1 mm thickness.

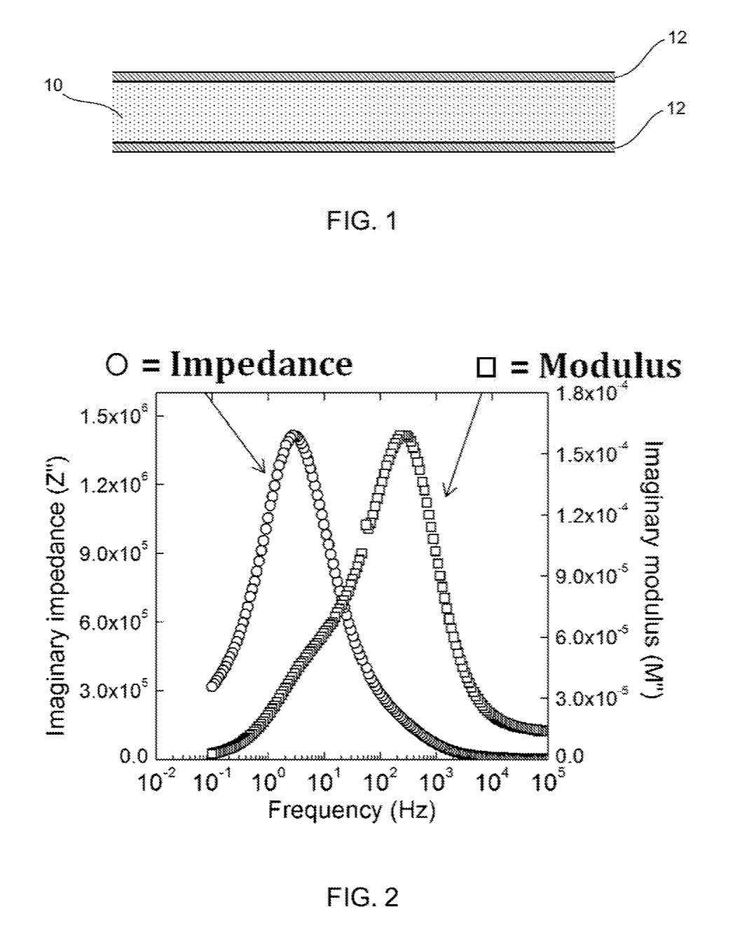

FIG. 1 shows the NBT-BMT material 10 sandwiched between two silver (Ag) electrodes 12. It is noted that this drawing and the other drawings herein are not to be considered as being to scale, and are thus, merely schematic to assist in showing and describing examples of the present disclosure. Furthermore, this example is provided to show an example of an oxygen conducting bismuth perovskite material as used in one application, although other material compositions can also be used in various other applications.

FIG. 2 shows a graph of impedance and dielectric modulus data measured using the NBT-BMT material and Ag electrodes. These measurements were conducted with an impedance analyzer measuring over the frequency range of 1 mHz to 10 MHz. The impedance data points are shown as circles in the figure, while modulus data points are shown as squares. One characteristic of oxygen conduction is the appearance of electrode polarization with the use of blocking metallic electrodes. This occurs because of the buildup of oxygen ions at the blocking metal-ceramic interface. A convoluted peak in the dielectric modulus data is clearly shown which is strongly correlated to the peak in impedance. This indicates the presence of a low frequency polarization due to oxygen pile up at the electrode.

### Example 2

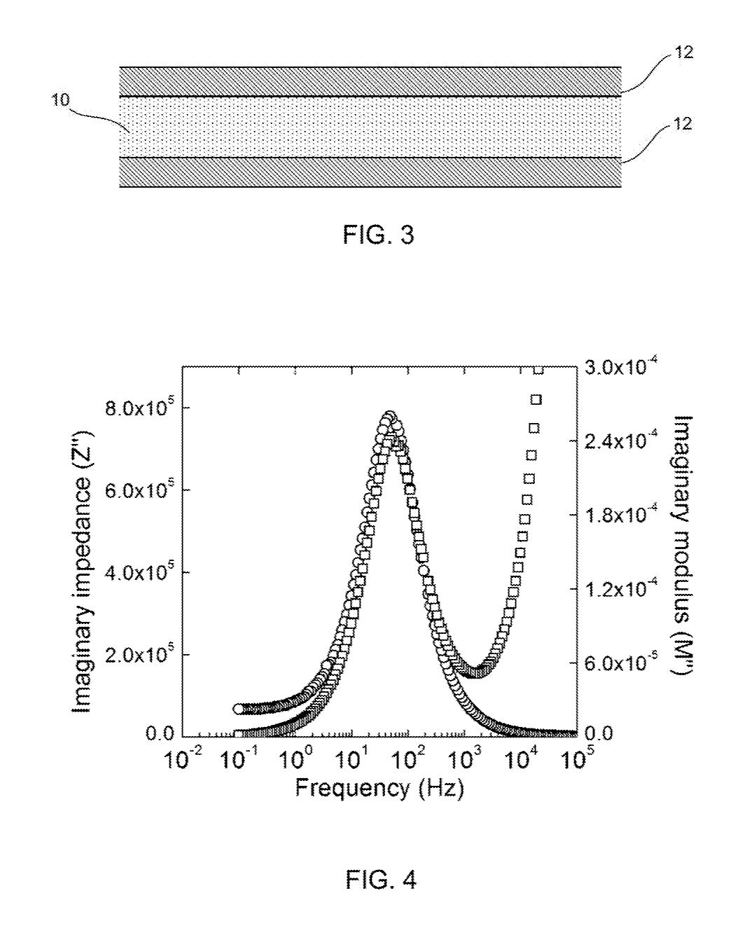

The same NBT-BMT material as described in Example 1 was placed between indium tin oxide (ITO) electrodes. Thin film electrodes of indium tin oxide (ITO) were applied to both sides of the specimen using DC magnetron sputtering in vacuum using standard methods. FIG. 3 shows the material 10 between the electrodes 12. FIG. 4 shows a graph of impedance and dielectric modulus data measured using the NBT-BMT material and ITO electrodes. The impedance data points are shown as circles in the figure, while modulus data points are shown as squares. The impedance and modulus data in this example have coincident peaks, suggesting that the conducting species (i.e. O) is not impeded at the electrode interface. While additional tests can be performed to confirm these results, this indicates the presence of oxygen conduction in the BNT-BMT material.

While the disclosure has been described with reference to certain examples, those skilled in the art will appreciate that various modifications, changes, omissions, and substitutions can be made without departing from the spirit of the disclosure. It is intended, therefore, that the present disclosure be limited only by the scope of the following claims.

What is claimed is:

1. An oxygen conducting bismuth perovskite material, comprising two components selected from the group consisting of NBT, KBT, BZT, BMT, and BNiT, wherein the material has a sufficient degree of non-stoichiometry to provide oxygen vacancies to conduct oxide ions.

2. The oxygen conducting bismuth perovskite material of claim 1, wherein the material comprises three components selected from the group consisting of NBT, KBT, BZT, BMT, and BNiT.

3. The oxygen conducting bismuth perovskite material of claim 1, wherein the material has a general formula selected from the group consisting of:
xNBT-yKBT-zBZT,
xNBT-yKBT-zBMT, and
xNBT-yKBT-zBNiT
wherein x+y+z=1 and x, y, z≠0

4. The oxygen conducting bismuth perovskite material of claim 1, wherein the material comprises a solid solution having a stable perovskite structure at standard conditions.

5. The oxygen conducting bismuth perovskite material of claim the material has an oxygen conductivity of at least 0.001 S/cm at 600° C.

6. The oxygen conducting bismuth perovskite material of claim 1, wherein the non-stoichiometry comprises a deficiency of bismuth.

7. The oxygen conducting bismuth perovskite material of claim 1, wherein the material further comprises a dopant.

8. The oxygen conducting bismuth perovskite material of claim 7, wherein the dopant is Mg at a concentration from about 1 at % to about 5 at %.

9. The oxygen conducting bismuth perovskite material of claim 1, wherein the material is piezoelectric or has electrostrictive characteristics.

10. The oxygen conducting bismuth perovskite material of claim 9, wherein the material has a maximum effective piezoelectric d₃₃* value from about 200 pm/V to about 700 pm/V.

11. The oxygen conducting bismuth perovskite material of claim 1, wherein an oxygen conductivity of the material can be modulated by applying a voltage, an external stress, an acoustic signal, or combinations thereof.

12. A method of conducting oxygen through a ceramic material, comprising passing oxide ions through oxygen vacancies in the material, wherein the material comprises two components selected from the group consisting of NBT, KBT, BZT, BMT, and BNiT.

13. The method of claim 12, wherein the oxide ions are passed through the material under a driving force comprising an internal electric field within the material.

14. The method of claim 12, further comprising adjusting an oxygen conductivity of the material by applying a voltage, an external stress, an acoustic signal, or combinations thereof.

15. A method of king an oxygen conducting ceramic material, comprising:
mixing starting powders selected from the group consisting of ZnO, NiO, MgO, MgCO₃, Bi₂O₃, TiO₂, NaCO₃, and KCO₃; and
sintering the starting powders to form an oxygen conducting ceramic material,
wherein the starting powders are selected according to a ratio such that the oxygen conducting ceramic material comprises two components selected from the group consisting of NBT, KBT, BZT, BMT, and BNiT, and the oxygen conducting ceramic material has a sufficient degree of non-stoichiometry to provide oxygen vacancies to conduct oxide ions
